(19) United States
(12) Patent Application Publication
(10) Pub. No.: US 2015/0242962 A1
(43) Pub. Date: Aug. 27, 2015

(54) COMPUTER SYSTEMS COMPRISING DATABASE CLUSTER SERVER AND USES THEREOF

(71) Applicant: THE BANCORP BANK, WILMINGTON, DE (US)

(72) Inventors: ERIN ALLARD, WILMINGTON, DE (US); FRANK MASTRANGELO, GLENMOORE, PA (US)

(21) Appl. No.: 14/630,292

(22) Filed: Feb. 24, 2015

Related U.S. Application Data
(60) Provisional application No. 61/944,015, filed on Feb. 24, 2014.

(51) Int. Cl. G06Q 40/00

(52) U.S. Cl. CPC G06Q 40/12

(57) ABSTRACT

The examples described in this disclosure can sweep deposit values from a noninterest-bearing first account to a noninterest-bearing second account. The first account can be maintained by a first institution, while the second account can be maintained by a second institution. The first institution can earn a deposit fee by sweeping values to the second account at the second institution. As such, the second account can be a noninterest-bearing account. Other examples provide additional structures and functions.

### CROSS-REFERENCE TO RELATED APPLICATIONS

This application claims priority to U.S. Provisional Application Ser. No. 61/944,015, filed Feb. 24, 2014, the contents of which is hereby incorporated by reference in its entirety for all purposes.

### BACKGROUND

Computational systems are used for storing, manipulating, and transferring electronic user account information. Such electronic user account information may correspond to numerical amounts or a quantity of something of value, such as money or assets. Oftentimes the electronic user account information is regulated. However, the values stored in such regulated electronic user accounts may be subjected to maximum limits, and any excess values assigned to the electronic information may be susceptible to loss. Consequently, computational systems can be designed to limit the numerical quantities of the values of such electronic user account information. It is also desired for institutions to manage the numerical quantities for each of a plurality of electronic user accounts. For example, an institution might have a greater amount of monetary assets in its plurality of electronic user accounts than necessary, while another institution may have a number of electronic user accounts requiring monetary assets. Accordingly, each institution may have an interest in managing its respective plurality of electronic user accounts in such a way that simultaneously benefits their electronic user accounts. As a result, computational systems are required to achieve these goals.

### SUMMARY

In accordance with an embodiment, a system may perform a process to sweep deposit values from a noninterest-bearing first account to a noninterest-bearing second account to limit balance values to a threshold amount. The system may comprise a database cluster server communicatively connected to a load-balanced application server. The database cluster server may comprise a first computing memory storing a balance sheet and a first plurality of electronic accounts. The balance sheet may include at least an institutional value, and each of the first plurality of electronic accounts may comprise a plurality of data parameters, including at least a balance value not accruing interest, a ledger sheet having an available-balance value initialized to the balance value, and an eligible decrement value. The database cluster server may also comprise a second computing memory storing a second plurality of electronic accounts. Each of the second plurality of electronic accounts may comprise a plurality of data parameters, including at least a balance value not accruing interest, a ledger sheet having an available-balance value initialized to the balance value, and an eligible decrement value. The load-balanced application server may have computer instructions stored thereon that, during execution, cause the system to perform operations that comprise the sweeping process. The process can include querying the first computing memory for a first electronic account of the first plurality of electronic accounts, calculating a threshold data value of the first electronic account based on one of the plurality of data parameters associated with the first electronic account, and comparing a balance value associated with the first electronic account to the threshold data value. Upon identifying that the balance value of the first electronic account exceeds the threshold data value, the process may further include querying the second computing memory for a second electronic account of the second plurality of electronic accounts, decrementing the balance value of the first electronic account and the institutional value of the balance sheet by a pre-selected amount without changing the available-balance value of the ledger sheet associated with the first electronic account, and incrementing the balance value of the second electronic account by the pre-selected amount.

In accordance with another embodiment, a system may perform a process to sweep deposit values from a noninterest-bearing first account to a noninterest-bearing second account to satisfy institution deposit requests. The system may comprise a computing memory communicatively connected to a server. The computing memory may have a database stored therein, the database storing a balance sheet and a plurality of electronic accounts wherein the balance sheet is associated with a first institution and includes at least an institutional value. Each of the plurality of electronic accounts may comprise a plurality of data parameters including at least a balance value not accruing interest, a ledger sheet having an available-balance value initialized to the balance value, and an eligible decrement value. The server may have computer instructions stored thereon that, during execution, cause the system to perform operations that comprise the sweeping process. The process can include querying the database to select an eligible decrement value from a first electronic account of the plurality of electronic accounts, wherein the first account is associated with the first institution. The process may also include calculating a difference between a requested amount of deposits requested by a second institution from the first institution and a received amount of deposits received by the second institution from the first institution. Upon identifying that the difference between the requested amount of deposits and the received amount of deposits is positive, the process may further include querying the database to select a second electronic account from the plurality of electronic accounts wherein the second account is associated with the second institution. The process may then include updating the database to decrement at least the selected eligible decrement value from both a respective balance value of the first electronic account in which the selected eligible decrement value is held and the institutional value of the balance sheet. Finally, the process may update the database to increment the balance value of the second electronic account by the amount decremented from the balance value of the first electronic account and the institutional value of the balance sheet.

In accordance with another embodiment, a system may perform a process to sweep deposit values from a noninterest-bearing first account to a noninterest-bearing second account to satisfy paying an electronic deposit fee. The system may comprise a computing memory communicatively connected to a server. The computing memory may have a database stored therein, the database storing a balance sheet and a plurality of electronic accounts wherein the balance sheet is associated with a first institution and includes at least an institutional value. Each of the plurality of electronic accounts may comprise a plurality of data parameters including at least a balance value not accruing interest. The server may have computer instructions stored thereon that, during execution, cause the system to perform operations that comprise the sweeping process. The process can include querying the database to identify a first electronic account associated with a second institution, wherein the balance value of the first electronic account comprises electronic deposits that have been decremented from respective balance values of at least one electronic account of the first institution and incremented to the balance value of the first electronic account. The process may include calculating an electronic deposit fee based upon the balance value of the identified first electronic account, querying the database to identify a second electronic account of the second institution, and querying the database to identify a third electronic account of the first institution. Next, the process may include updating the database to decrement at most the electronic deposit fee from the balance value of the second electronic account at a time based upon the electronic deposit fee paid by the second institution to the first institution and updating the database to increment both the balance value of the third electronic account and the institutional value of the balance sheet by the amount decremented from the balance value of the second electronic account.

### BRIEF DESCRIPTION OF THE DRAWINGS

The foregoing summary, as well as the following detailed description of an example embodiment of the application, will be better understood when read in conjunction with the appended drawings, in which there is shown in the drawings example embodiments for the purposes of illustration. It should be understood, however, that the application is not limited to the precise examples shown. In the drawings:

FIG. 1 is a block system diagram illustrating a schematic of computers and servers for sweeping values;

FIG. 2 is a block diagram of an example processing entity.

FIG. 3 is a flow diagram showing an example process of sweeping values;

FIG. 4 is a flow diagram illustrating another example process of sweeping values;

FIG. 5 is a flow diagram illustrating a more detailed example process of sweeping values;

FIG. 6 is a flow diagram illustrating an example process of sweeping values;

FIG. 7 is a flow diagram illustrating another example process of sweeping values;

FIG. 8 is a flow diagram illustrating yet another example process of sweeping values;

FIG. 9 is a flow diagram illustrating an example process of determining the required demand of one or more participating institutions to receive swept deposit values;

FIG. 10 is a flow diagram illustrating an example process of determining the required demand of one or more participating institutions to receive swept deposit values; and

FIG. 11 is a flow diagram illustrating a process of a noninterest-bearing account holder participating in a sweep program.

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### DETAILED DESCRIPTION

Described in detail below are examples of electronically sweeping values from a providing institution to one or more omnibus accounts at one or more participating institutions and accordingly decrementing the providing institution's balance sheet by the swept amount. One example of such a sweeping may be decrementing balance values of accounts of a providing institution and incrementing the balance values of accounts of a participating institution by the amount decremented from the accounts of the first institution. The sweeping may be performed by various system components including, for example, a database cluster server and a load-balanced application server communicatively connected together. It should be appreciated that the one or more participating institutions may be external institutions that are separate and distinct from the providing institution. An example institution may be a bank or other financial institution interested in transferring monetary balances between accounts and other financial institutions. The one or more participating institutions may receive swept deposits from the providing institution. The swept deposits may remain available to deposit account holders as though the swept deposits were still on the providing institution's balance sheet. Deposit account holders having electronic access may be able to see the full balance value of their respective accounts at the providing institution and also the amount and location of the swept deposits at the one or more participating institutions. This information may be found on a ledger sheet associated with the account.

The example embodiments may refer to a sweep ecosystem, a sweep system, a sweep program, etc. It should be appreciated that sweeping can occur at an account level: for example, sweeping from the balance value of one account to the balance value of another account at the same or different institution. At minimum, accounts (“accounts” or “electronic accounts”) have an associated balance value (“balance value” or “balance value parameter”) and are capable of having various other associated variables and data parameters. For example, such variables and data parameters in addition to the balance value might include an eligible decrement amount and a ledger sheet, the ledger sheet further having an available-balance value. In non-limiting example, a balance value might represent monetary funds or deposits associated with its respective account.

Example Processing Environment

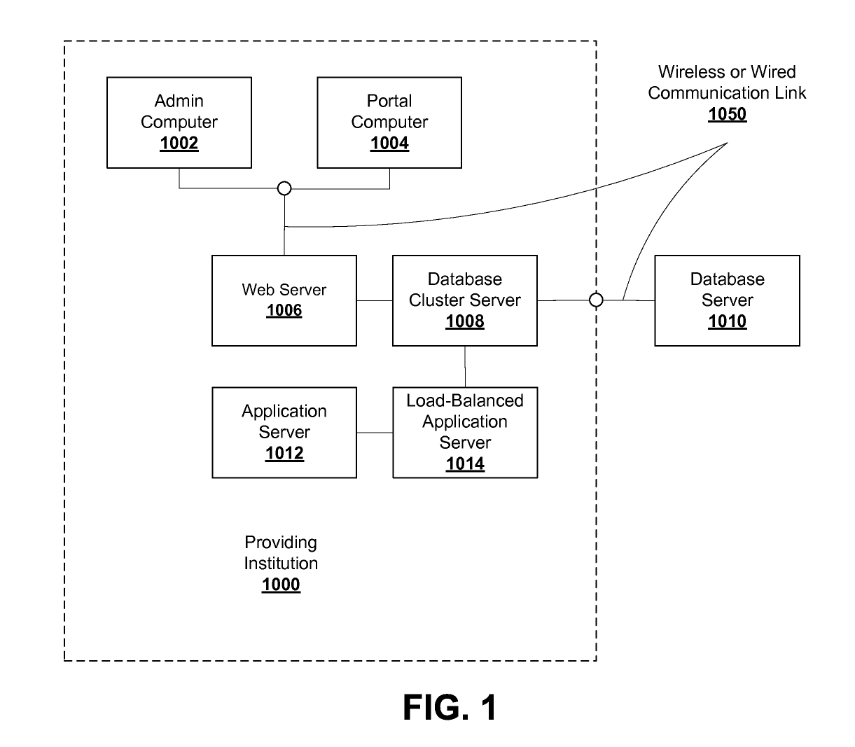

FIG. 1 illustrates a system that may perform the sweep program. The system may include an admin computer 1002, a portal computer 1004, a web server 1006, a database cluster server 1008, an application server 1012, and/or a load-balanced application server 1014 communicatively connected in a network. The network may be communicatively connected to a database server 1010. It should be appreciated that any of the system components may be communicatively connected via a wired or wireless connection 1050.

It should be appreciated that any of the system components may comprise a processor and memory coupled to the processor. The memory may include executable instructions that, when executed by the processor, cause the processor to effectuate any of the operations described in this disclosure. For example, the admin computer 1002 can be used to perform administrative operations, such as making changes to which participating institution(s) may receive swept deposits from the first account, the load-balanced application server 1014 may perform the sweeping process, and the database cluster server 1008 may process and store account data.

The portal computer 1004 may be communicatively connected to the admin computer 1002 via a wired or wireless connection 1050. The portal computer 1004 may be used to perform operations such as opting in and/or opting out of participating in the sweep program as well as determining available balance values (X) and/or any other such information that the account holder might request in regards to the first account.

The admin computer 1002 and/or the portal computer 1004 may be communicatively connected via a wired or wireless connection 1050 to the web server 1006. It should be appreciated that the admin computer 1002 and/or the portal computer 1004 can be located behind a firewall, such as a software firewall, a hardware firewall, or a combination of the two. As well, it should be appreciated that the firewall can be used to achieve secured data transmissions between the admin computer 1002, the portal computer 1004, and/or the web server 1006.

The web server 1006 can be a server that delivers web content, which can be accessed through the Internet. For example, the web server 1006 can host any suitable website that delivers account information to the account holder and/or an internal website that is maintained by the providing institution for internal management of the first account. The web server 1006 may perform other operations, such as storing data or running enterprise applications.

The database cluster server 1008 may download and store account data from the database server 1010. The database server 1010, which may be maintained by a third party, may store any account level data, such as any of the variables described in this disclosure, which may be available to the providing institution via the database cluster server 1008. The database cluster server 1008 may include any number of computing memories or databases for storing pluralities of electronic accounts as well as institution data, such as the institution's balance sheet. The database cluster server's 1008 memories may be queried to identify accounts stored therein.

The application server 1012 may perform operations such as scheduling and/or initiating of daily processes on any of the computers and/or servers within the network. For example, the application server 1012 may transmit instructions to direct the load-balanced application server 1014 to begin performing any of the steps described in this disclosure. Accordingly, the load-balanced application server 1014 may perform any combination of the steps described within this disclosure. For example, the load-balanced application server 1014 may query the database cluster server 1008 for a first electronic account of the plurality of electronic accounts it stores. The load-balanced application server 1014 may next calculate a threshold data value of the first electronic account based on one of the data parameters associated with the first electronic account and then compare, or calculate the difference between, the threshold data value and the balance value of the first electronic account. If the load-balanced application server 1014 finds that the balance value is greater than the threshold data value, or that the difference is positive, the load-balanced application server 1014 may then query the database cluster server 1008 for a second electronic account, decrement, or update the database to decrement, the balance value of the first electronic account by a pre-selected amount, and increment, or update the database to increment, the balance value of the second electronic account by the pre-selected amount. During the decrementing process, the load-balanced application server 1014 will also decrement the institutional balance sheet the first electronic account is associated with; however, it will not change the ledger sheet of the first electronic account.

It should also be appreciated that any of the computers and/or servers described herein may be communicatively connected via a wired or wireless connection 1050 to a disaster recovery server that may be physically located at a different location from the respective server that it is backing up. For example, the web server 1006 may be communicatively connected to a disaster recovery web server. In the event that a disaster decommissions the web server 1006, the disaster recovery web server may help to continue delivering web content so as to minimize any interruptions to any websites that the web server 1006 is hosting.

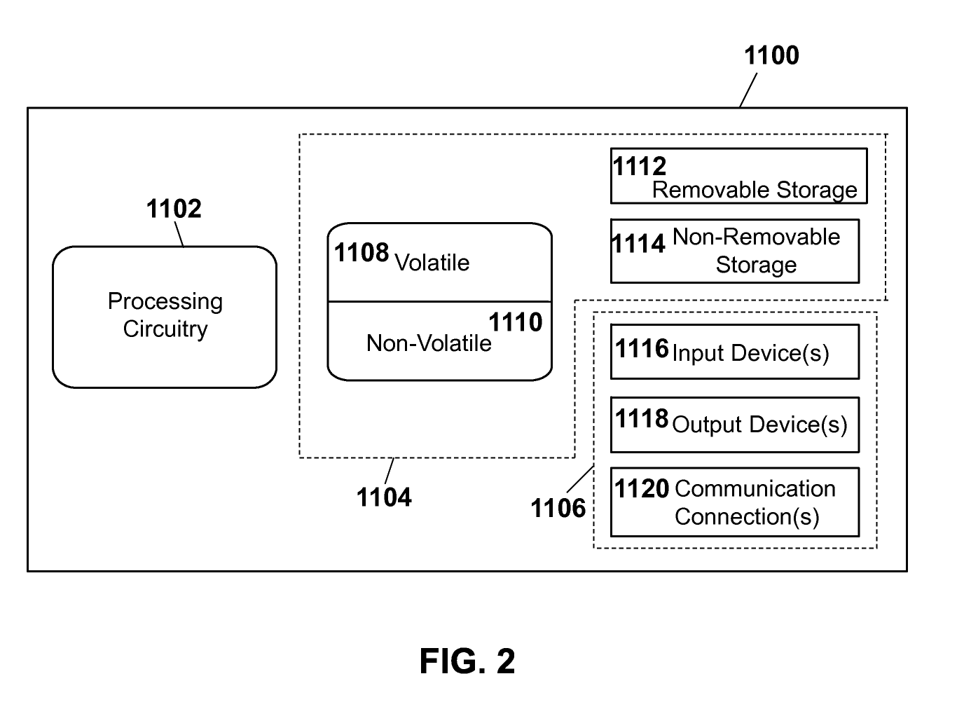

FIG. 2 is a block diagram of an example processing entity 1100 that may be utilized to implement sweeping values as described herein. For example, the processing entity 1100 might be utilized in the application server 1012, the database cluster server 1008, and the load-balanced application server 1014. It should be appreciated that the processing entity 1100 may be configured to perform any of the steps described in this disclosure. Additionally, any of the system components, apparatuses, and/or computer-readable medium described in this disclosure may include a processing entity 1100. For example, the web server 1006, load-balanced application server 1014, and/or database cluster server 1008 may be implemented via the processing entity 1100.

The processing entity 1100 may comprise hardware or a combination of hardware and software. In an example embodiment, the processing entity 1100 may comprise a network entity and when used in conjunction with a network, the functionality needed to sweep deposit values. The processing entity 1100 depicted in FIG. 2 may represent any appropriate network entity, or combination of network entities, such as, for example, a component or various components of a cellular broadcast system wireless network, a processor, a server, a gateway, a node, a MSC, a SMSC, a GMLC, a RAN, a SMLC, or any appropriate combination thereof. It is emphasized that the block diagram depicted in FIG. 2 is exemplary and not intended to imply a specific implementation or configuration. Thus, the processing entity 1100 may be implemented in a single device or multiple devices (e.g., single server or multiple servers, single gateway or multiple gateways, etc.). Multiple network entities may be distributed or centrally located. Multiple network entities may communicate wirelessly, via hard wire, or any appropriate combination thereof.

In an example embodiment, the processing entity 1100 may comprise a processor and memory coupled to the processor. The memory may comprise executable instructions that when executed by the processor cause the processor to effectuate operations associated with sweeping values as described herein. As evident from the herein description, the processing entity 1100 is not to be construed as software per se.

In an example configuration, the processing entity 1100 may comprise a processing portion 1102, a memory portion 1104, and an input/output portion 1106. The processing portion 1102, memory portion 1104, and input/output portion 1106 may be coupled together (coupling not shown in FIG. 2) to allow communications there between. Each portion of the processing entity 1100 may comprise circuitry for performing functions associated with each respective portion. Thus, each portion of the processing entity 1100 may comprise hardware, or a combination of hardware and software. Accordingly, each portion of the processing entity 1100 is not to be construed as software per se. The input/output portion 1106 may be capable of receiving and/or providing information from/to a communications device and/or other network entities configured to implement sweeping values as described herein. For example, the input/output portion 1106 may include a wireless communications (e.g., 2.5G/3G/4G/GPS) card. The input/output portion 1106 may be capable of receiving and/or sending video information, audio information, control information, image information, data, or any combination thereof. In an example embodiment, the input/output portion 1106 may be capable of receiving and/or sending information to determine a location of the processing entity 1100 and/or the communications processing entity 1100. In various configurations, the input/output portion 1106 may receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof.

The processing portion 1102 may be capable of performing functions associated with sweeping values (e.g., sweeping values from a noninterest-bearing first account to a noninterest-bearing second account, or any of the steps described in this disclosure, etc.) as described herein. For example, the processing portion 1102 may be capable of, in conjunction with any other portion of the processing entity 1100, installing an application to implement sweeping values as described herein.

In a basic configuration, the processing entity 1100 may include at least one memory portion 1104. The memory portion 1104 may comprise a storage medium having a concrete, tangible, physical structure. Thus, the memory portion 1104, as well as any computer-readable storage medium described herein, is not to be construed as a transient signal per se. The memory portion 1104, as well as any computer-readable storage medium described herein, is not to be construed as a propagating signal per se. The memory portion 1104, as well as any computer-readable storage medium described herein, is to be construed as an article of manufacture. The memory portion 1104 may store any information utilized in conjunction with receiving information from an observation device, receiving information from an intermediate device that communicates with an observation device, as described herein. Depending upon the exact configuration and type of processor, the memory portion 1104 may be volatile 1108 (such as some types of RAM), non-volatile 1110 (such as ROM, flash memory, etc.), or a combination thereof. The processing entity 1100 may include additional storage (e.g., removable storage 1112 and/or non-removable storage 1114) including, for example, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the processing entity 1100.

The processing entity 1100 also may contain communications connection(s) 1120 that allow the processing entity 1100 to communicate with other devices, network entities, or the like. A communications connection(s) may comprise communication media. Communication media typically embody computer readable instructions, data structures, program modules or other data in a modulated data signal such as a carrier wave or other transport mechanism and includes any information delivery media. By way of example, and not limitation, communication media may include wired media such as a wired network or direct-wired connection, and wireless media such as acoustic, RF, infrared, and other wireless media. The term computer readable media as used herein includes both storage media and communication media. The processing entity 1100 also may include input device(s) 1116 such as keyboard, mouse, pen, voice input device, touch input device, etc. Output device(s) 1118 such as a display, speakers, printer, etc. also may be included.

A device, an observation device, a processing entity, or any appropriate combination thereof, as described herein, may be part of and/or communicate with various wireless communications networks. Some of which are described below.

It should be appreciated that any of these process steps may be implemented via system components that include a processor and memory coupled to the processor. The memory may include executable instructions that, when executed by the processor, cause the processor to effectuate operations of any of the steps described in this disclosure. It should also be appreciated that the process may be implemented using computer-readable storage media found in the system components. As well, the computer-readable storage media may include executable instructions that, when executed by a processor, cause the processor to effectuate operations of any of the steps described in this disclosure.

Example Sweeping Processing

A deposit account at a providing institution may be a noninterest-bearing account, an account having a balance value that does not accrue interest. As well, the one or more accounts at the one or more participating institutions may also be noninterest-bearing accounts. As such, the disclosure may include sweeping deposit values from a noninterest-bearing electronic account at a providing institution to a noninterest-bearing electronic account at a participating institution. It should also be appreciated that the providing institution may earn a deposit fee for sweeping the deposit values to such participating institutions.

As may be required by government regulatory agencies, such as the Federal Deposit Insurance Corporation (FDIC), the providing institution may have to gain authorization from the deposit account holders to participate in the sweep ecosystem. As such, disclosures may be made to clients as to the sweep ecosystem, giving the account holders the ability to consent to participate in the sweep ecosystem. It should also be appreciated that the account holders may have the ability to consent to sweeping deposit values to and/or from specific participating institutions. For example, the account holder may be able to authorize the providing institution to sweep deposit values to participating institutions A, B and D, but not participating institution C. As well, it should be appreciated that the consent to participate may be an active or passive input. For example, the account holder may actively consent to participate in the sweep ecosystem by checking an electronic box on a website. The account holder may passively consent to participate in the sweep ecosystem by keeping their respective account open for a predetermined amount of time.

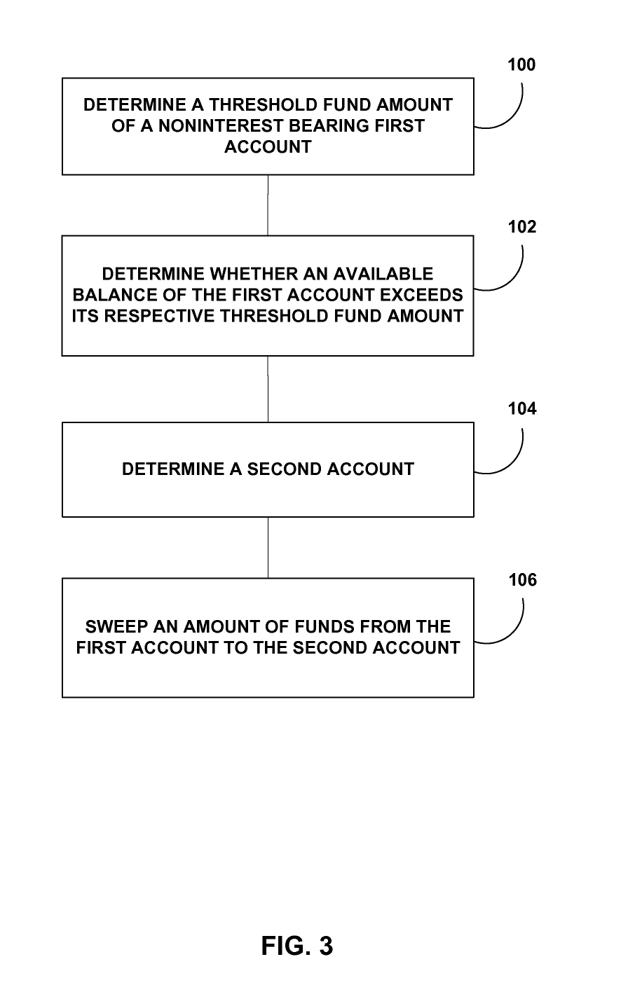

FIG. 3 is a flowchart illustrating an example process of sweeping values using the sweep system described above. Each day, the database cluster server 1008 performs a download of all account data from database server 1010 to the computing memories and/or databases of the database cluster server 1008 so that the load-balanced application server 1014 and database cluster server 1008 may have direct access to account data. Each computing memory and/or database may store a plurality of electronic accounts. Each electronic account may have a plurality of associated data parameters, including a balance value not accruing interest, a ledger sheet having an available-balance value initialized to the balance value, and an eligible decrement value. The database cluster server 1008 also stores a balance sheet having at least an institutional value parameter, the balance sheet being associated with an institution. The application server 1012 initiates the scheduled daily sweeping processes and transmits instructions to the load-balanced application server 1014. It is to be understood that the load-balanced application server 1014 may perform any or all actions using either its own stored computer instructions or taking direction of the application server 1012. After initiation of the sweeping process, the load-balanced application server 1014 may then query a computing memory and/or database of the database cluster server 1008 to identify a first electronic account. The load-balanced application server 1014 may then determine a threshold data value of the first electronic account (at step 100). Determining the threshold data value in the load-balanced application server 1014 may be based on any suitable parameter of the plurality of parameters associated with the first electronic account. For example, the threshold data value may be equal to the difference between the balance value (X) of the first electronic account and an eligible decrement amount (N_{A}), or (X−N_{A}). In some examples, the balance value (X) may be equal to the eligible decrement amount (N_{A}), and accordingly the threshold data value may be equal to zero. It should also be appreciated that in some examples, the amount of values swept from the first electronic account may be equal to the eligible decrement amount (N_{A}). As such, the amount of values swept may be equal to the balance value (X), or any value less than the balance value (X). However, this is just one example; the threshold data value may be based on any suitable parameter, such as balance value (X), eligible decrement amount (N_{A}), or the like.

It should be appreciated that any of the parameters may be based upon one another. For example, the eligible decrement amount (N_{A}) may refer to an amount that is capable of being swept from an account balance value, as calculated by the load-balanced application server 1014, which may be based upon the balance value (X). As described in mathematical terms, the eligible decrement amount (N_{A}) may be equal to (X).

The availability of deposits in the first electronic account may be indicated via an available-balance value of a ledger sheet parameter associated with the first electronic account in the database cluster server 1008. The available-balance value is originally initialized to the balance value of the first electronic account.

With continued reference to step 100, any suitable apparatus within the load-balanced application server 1014, such as a processor, server, or the like, may be used to query the database cluster server 1008 for the first account, as described in step 100. It should be appreciated that the apparatus may be implemented in a single device or multiple devices (e.g. single server or multiple servers, single gateway or multiple gateways, etc.).

The process may include the load-balanced application server 1014 determining whether a balance value (X) of the first account exceeds the threshold data value (at step 102). In a non-limiting example, this determining may be performed by comparing the balance value (X) to the threshold data value to observe which is greater. In another non-limiting example, the determining may be performed by calculating the difference between the balance value (X) and the threshold data value and observing if the result is positive or negative. Upon a determination that the balance value of the first account exceeds the threshold data value, the process may include the load-balanced application server 1014 querying a computing memory and/or database of the database cluster server 1008 to identify a second electronic account from the database cluster server 1008 (at step 104).

The process may further include the load-balanced application server 1014 sweeping an amount of values from the first account to the second account (at step 106). The availability of values swept from the first account to the second account may be updated by the load-balanced application server 1014 and indicated on the ledger sheet of the first account in the database cluster server 1008. Further, the load-balanced application server 1014 may update the balance sheet of the institution associated with the first electronic account to reflect the change. Together, these steps entail the load-balanced application server 1014 decrementing the balance value of the first electronic account and the institutional value of the balance sheet by a pre-selected amount, but leaving the available-balance value of the ledger sheet of the first electronic account unchanged. Then, the load-balanced application server 1014 increments the balance value of the second electronic account by the value decremented from the first electronic account. In some embodiments, the first account is associated with and/or maintained by a providing institution and the second account is associated with and/or maintained by a participating institution. However, it should also be appreciated that any combination is possible; for example, the first account may be maintained by a participating institution and the second account may be maintained by a providing institution. Even still, in some embodiments, the first account may be a providing-institution type account, and the second account may be a participating-institution type account.

The process may further include the load-balanced application server 1014 querying a computing memory and/or database of the database cluster server 1008 to identify a third electronic account from the database cluster server 1008. The load-balanced application server 1014 may then sweep an amount of values from the first account to the third account. The availability of values swept from the first account to the third account may be updated by the load-balanced application server 1014 and indicated on the ledger sheet of the first account in the database cluster server 1008. Further, the load-balanced application server 1014 may update the balance sheet of the institution associated with the first electronic account to reflect the change. Together, these steps entail the load-balanced application server 1014 decrementing the balance value of the first electronic account and the institutional value of the balance sheet by a pre-selected amount, but leaving the available-balance value of the ledger sheet of the first electronic account unchanged. Then, the load-balanced application server 1014 increments the balance value of the third electronic account by the value decremented from the first electronic account. The third electronic account may be associated with and/or maintained by a providing institution or participating institution.

The process illustrated in FIG. 3 may include determining, via the load-balanced application server 1014, a sweep eligibility status of the first account, second account, third account, or the like. Each account in the database cluster server 1008 may have a sweep eligibility status indicator, which may include one of: sweep eligible, sweep ineligible, or any term that describes a status of a noninterest-bearing account. It should be appreciated that the process may include the load-balanced application server 1014 determining a noninterest-bearing account status of any of the accounts disclosed in the database cluster server 1008. The account status may include open, closed, disabled, or any other term that describes a status of the account. Accordingly, the process may include the load-balanced application server 1014 flagging the first account, second account, third account, or the like as having any combination of the following: sweep eligible, sweep ineligible, open, closed, disabled, etc. The process may include the load-balanced application server 1014 determining whether any of the accounts have previously been swept.

In some embodiments the process may include the load-balanced application server 1014 calculating a first deposit fee that may be associated with the amount of values swept by the load-balanced application server 1014 from the noninterest-bearing first account to the noninterest-bearing second account. The first deposit fee may be a fee that is paid by a participating institution to a providing institution for deposit values that have been swept to the participating institution. The amount of the deposit fee may be determined by the amount of deposit values swept from the providing institution to the participating institution. In some embodiments the process may include receiving a first deposit fee. Specifically, the providing institution may receive a first deposit fee from the participating institution.

With continued reference to the example process illustrated in FIG. 3, the process may include the load-balanced application server 1014 identifying a noninterest-bearing first account, a noninterest-bearing second account, a noninterest-bearing third account, and/or at least one participating institution to participate in the sweep program. It should be appreciated that the identifying step may occur automatically based on a condition being satisfied. For example, the identifying step may automatically occur at a predetermined time of day or at a predetermined time interval.

In some instances, a noninterest-bearing second account may not exist at the time of the sweep. In this circumstance, the process may include the load-balanced application server 1014 establishing a noninterest-bearing second account at a participating institution. Similar to the previous identifying step, the establishing step may occur automatically based on a condition being satisfied. For example, if a noninterest-bearing first account holder using a portal computer 1004 authorizes a participating institution to receive swept deposit values from the noninterest-bearing first account, a noninterest-bearing second account may be established by the load-balanced application server 1014 at the participating institution.

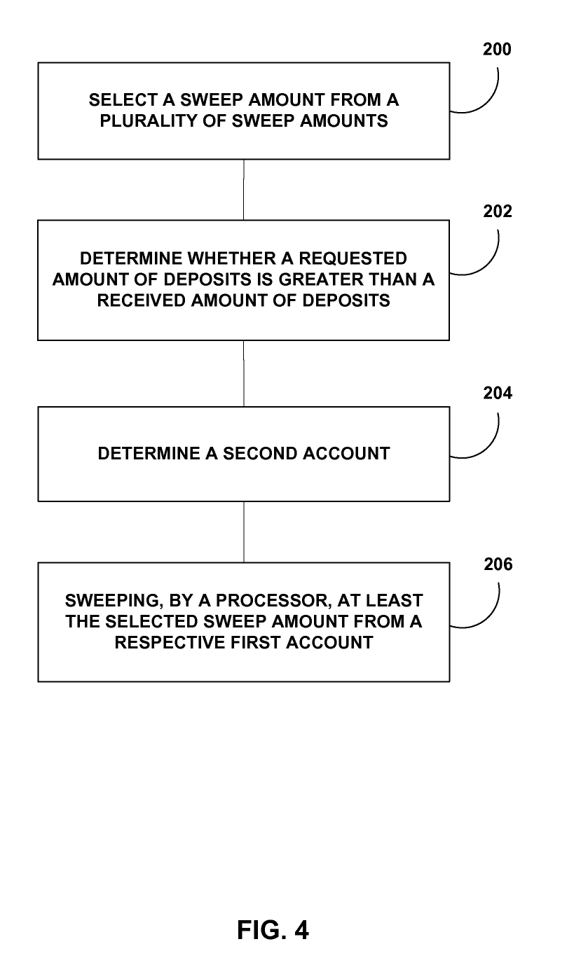

FIG. 4 illustrates another example process of sweeping from a noninterest-bearing first account to a noninterest-bearing second account. The process may include the load-balanced application server 1014 selecting a sweep amount from a plurality of sweep amounts (at step 200). Each sweep amount of the plurality of sweep amounts may be held in a respective first account in the database cluster server 1008. This may be performed by querying a database holding a plurality of electronic accounts to select an eligible decrement value from a first electronic account of the plurality of electronic accounts. The first account may be associated with the first institution. The process may then include the load-balanced application server 1014 determining whether a requested amount of deposits requested by a second institution from a first institution is greater than a received amount of deposits received by the second institution from the first institution (at step 202). This determining may be performed by calculating a difference between a requested amount of deposits requested by a second institution from the first institution and a received amount of deposits received by the second institution from the first institution. Upon a determination that the requested amount of deposits is greater than the received amount of deposits, which may be performed by identifying that the difference between the requested amount of deposits and the received amount of deposits is positive, the process may include determining the second account (at step 204). Determining the second account may be performed by querying the database to select a second electronic account from the plurality of electronic accounts. The second account may be associated with the second institution. The process may include sweeping, by a processor in the load-balanced application server 1014, at least the selected sweep amount from a respective first account, in which the selected sweep amount is held, to the second account (at step 206) and updating the institutional balance sheet accordingly. This process may be performed by updating the database to decrement at least the selected eligible decrement value from both a respective balance value of the first electronic account in which the selected eligible decrement value is held and the institutional value of the balance sheet, and then updating the database to increment the balance value of the second electronic account by the amount decremented from the balance value of the first electronic account and the institutional value of the balance sheet.

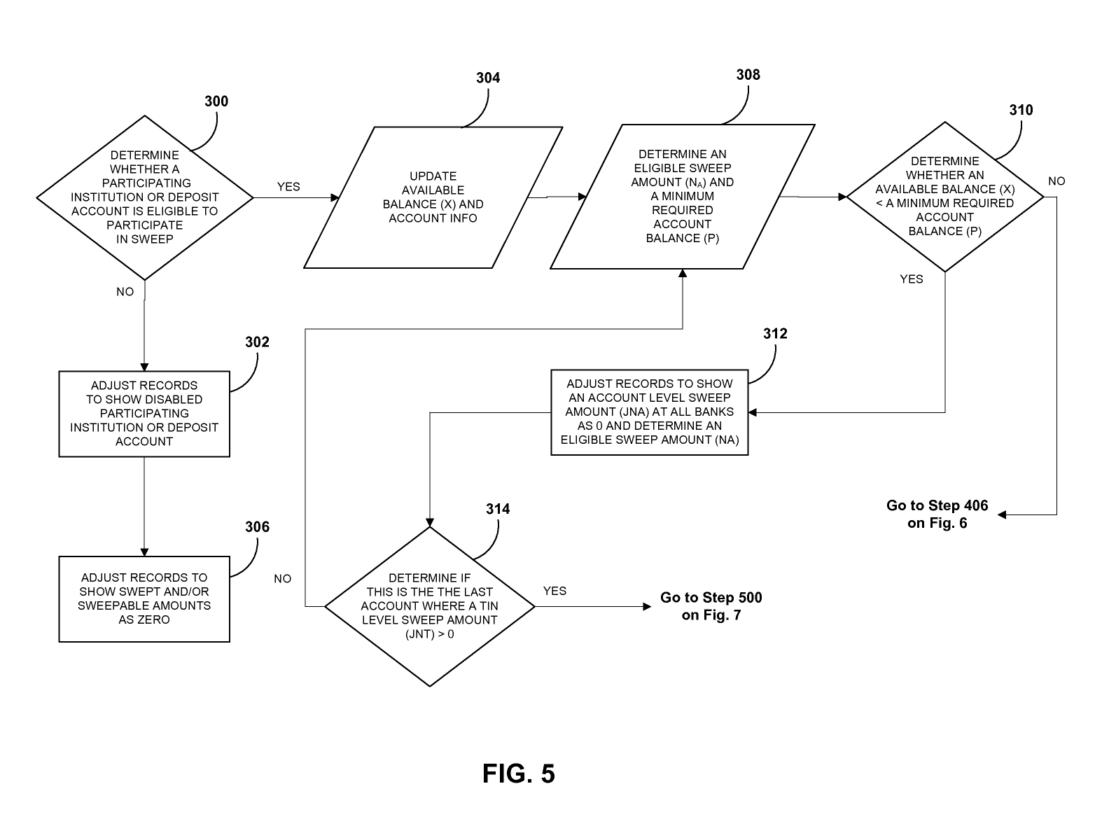

FIG. 5 illustrates a more detailed example process of sweeping values from a providing institution. The process may include the load-balanced application server 1014 determining whether a participating institution or deposit account is eligible to participate in the sweep program (at step 300). This determination may be accomplished by a variety of processes. In some processes, determining may include satisfying a condition, which indicates that a participating institution or deposit account is eligible to participate in the sweep. In some processes, the condition may require that a deposit account balance surpass a threshold limit, and, if surpassed, the deposit account may then be eligible to participate in the sweep program. In some processes, the condition may require that a deposit account balance falls below a threshold limit, and if the balance falls below, then the deposit account may then be no longer eligible to participate in the sweep program. As well, the condition may require a participating institution to have a positive required sweep amount (S), which may indicate that the participating institution is then eligible to participate in the sweep program. Alternatively, the condition may require a participating institution to have a negative required sweep amount (S) value, which may indicate that the participating institution is no longer eligible to participate in the sweep program. These are just a few examples of the numerous different ways that one of skill in the art could determine whether a participating institution or a deposit account is eligible to participate in the sweep program.

It should also be noted that while the process steps described in this disclosure may, for example, only refer to one singular account or one singular institution, this should not be construed as a limitation to the scope and intent of the process. For example, the process may be performed on one singular account, or a plurality of accounts. Likewise, the process may be performed on one singular institution, or a plurality of institutions.

With continued reference to the process illustrated in FIG. 5, upon a determination that no participating institutions and no deposit accounts are eligible to participate in the sweep program, the process may include adjusting records to show that a participating institution and/or a deposit account has been disabled (at step 302). The process may include adjusting records to show variables within the records, such as a swept amount of values, a sweepable amount of values, a threshold amount of values, and/or any other like variable, as being equal to zero (at step 306). Updating may be performed by the load-balanced application server 1014, database cluster server 1008, or any system component having access to the records.

Upon a determination that at least one participating institution and/or at least one deposit account is eligible to participate in the sweep program, the process may include updating deposit account variables, such as available balance (X) and any other account information (at step 304). Updating may be performed by the load-balanced application server 1014, database cluster server 1008, or any system component having access to the records. The variables may be updated to determine the most current deposit account information. In some embodiments, the updated variables may be used to rank participating institutions and/or deposit accounts against one another to sweep values in an order according to the desired ranked attribute.

The process may include the load-balanced application server 1014 determining an eligible decrement amount (N_{A}) for deposit account that have not previously been swept and/or determining a minimum required account balance (P) for all deposit accounts that have previously been swept. The minimum required account balance (P) may be based upon any of the other variables described in this disclosure. For example the minimum required account balance (P) may be described as a difference between the available balance (X) and the eligible decrement amount (N_{A}), or P=(X−N_{A}). It should also be appreciated that some embodiments may include the load-balanced application server 1014 determining a difference between at least two of any of the variables described in this disclosure. As well, it should be appreciated that any number of variables may be compared over any time span.

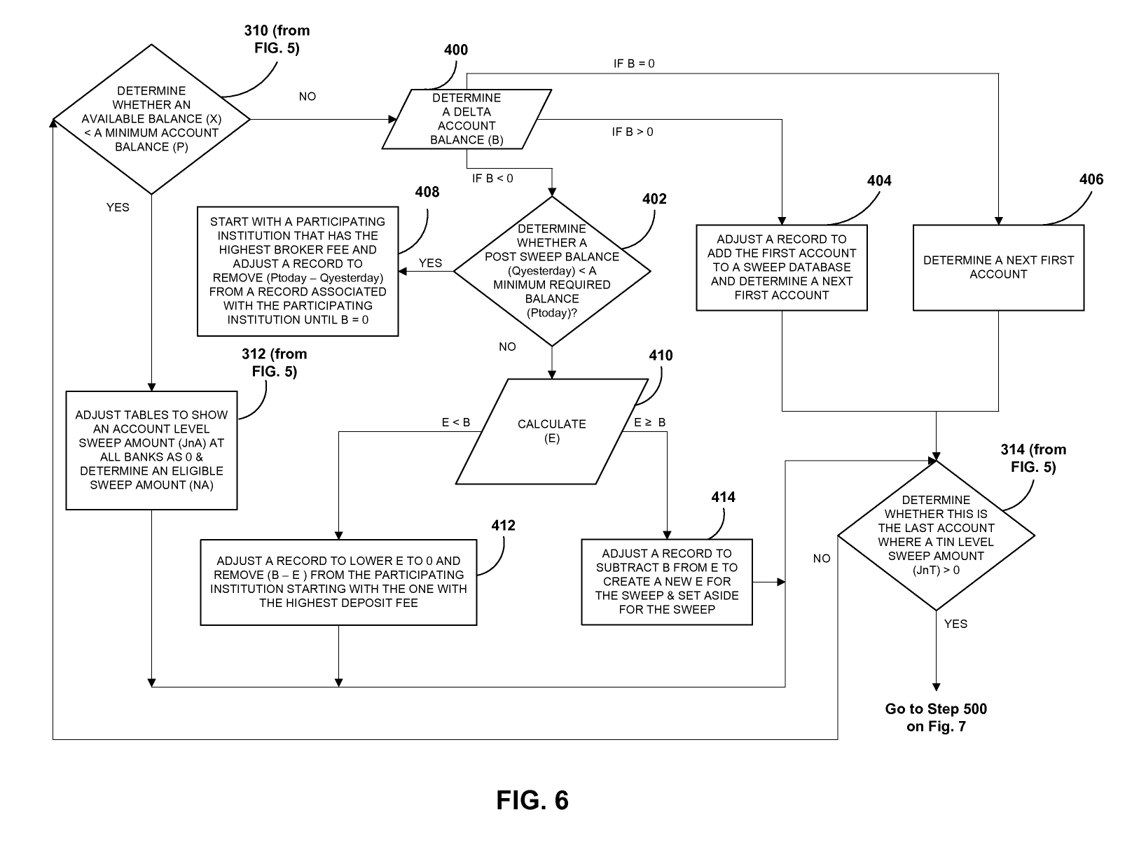

The process may include the load-balanced application server 1014 determining whether an available balance (X) is less than a minimum required account balance (P) (at step 310). Upon a determination that the available balance (X) is not less than the minimum required account balance (P), the process may continue at step 400, which is illustrated in FIG. 6 and discussed with regard to FIG. 6, below.

Upon a determination that the available balance (X) is less than the minimum required account balance (P), the process may include adjusting records to show that an account level sweep amount (J_{nA}), which are values swept to a participating institution, are equal to zero (at step 312). Furthermore, step 312 may include determining an eligible decrement amount (N_{A}). It should be appreciated that the “n” in “J_{nA}” may refer to a participating institution number, while the “A” may refer to the sweep occurring at an account level. The disclosure may refer to a TIN level sweep amount (J_{nT}) that are values swept to a participating institution. It should be appreciated that “TIN” may describe a taxpayer identification number. To further describe the TIN level sweep amount (J_{nT}), whereby the account level sweep amount (J_{nA}) may describe the amount of values swept from individual accounts, the TIN level sweep amount (J_{nT}) may describe the cumulative amount of values swept to/from all of a noninterest-bearing account holder's (or taxpayer's) accounts to a participating or providing institution.

In some processes, the account level sweep amount (J_{nA}) may be determined by the required sweep amount (S). For example, if the load-balanced application server 1014 finds that the required sweep amount (S) from a select participating institution is greater than an eligible decrement amount (N_{A}), then the account level sweep amount (J_{nA}) may be equal to the eligible decrement amount (N_{A}). As well, if the required sweep amount (S) from the participating institution is less than the account level sweep amount (J_{nA}), then the account level sweep amount (J_{nA}) may be equal to the required amount (S) from the select participating institution. It should also be appreciated that the account level sweep amount (J_{nA}) may be described in any other suitable manner.

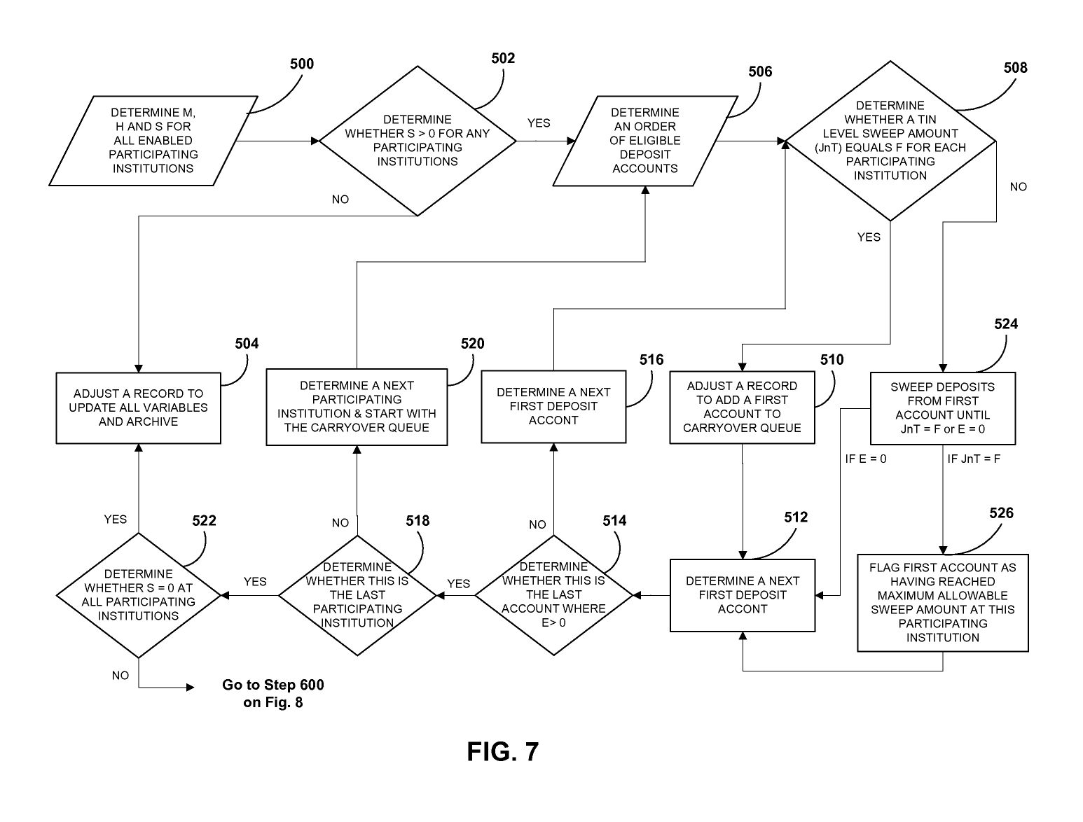

The example process illustrated in FIG. 5 may include the load-balanced application server 1014 determining whether this is the last account where the TIN level sweep amount (J_{nT}) is greater than a value of zero (at step 314). Upon a determination that the first account is the last account where the TIN level sweep amount (J_{nT}) is not greater than zero, the process may continue with step 308, as previously discussed. Upon a determination that the first account is the last account where the TIN level sweep amount (J_{nT}) is greater than zero, then the process may continue at step 50, which is illustrated in FIG. 7 and described below.

The example process illustrated in FIG. 6 may include the step of the load-balanced application server 1014 determining a delta account balance (B) of the first account (at step 400). The delta account balance (B) may equal a difference between today's available balance (X_{Today}) and yesterday's available balance (X_{yesterday}), or B=(X_{Today}−X_{Yesterday}). It should be appreciated that the delta account balance (B) may equal a difference between any two available balances (X) chosen over any period of time. For example, the delta account balance (B) may equal a difference between yesterday's available balance (X_{Yesterday}) and an available balance from three days ago (X_{ThreeDaysAgo}), or B=(X_{Yesterday}−X_{ThreeDaysAgo}).

From step 400, upon a determination that the delta account balance (B) of the first account is less than a value of zero, the process may include the load-balanced application server 1014 determining whether yesterday's post sweep balance (Q_{Yesterday}) is less than today's minimum required account balance (P_{Today}) (at step 402). Yesterday's post sweep balance (Q_{Yesterday}) may be equal to the difference between yesterday's available balance (X_{Yesterday}) and a maximum allowable sweep amount (F), or Q_{Yesterday}=(X_{Yesterday}−F). The maximum allowable sweep amount (F) may be based upon a government provided deposit insurance limit (e.g. in the U.S. —FDIC deposit insurance limit). For example, in the U.S., the maximum allowable sweep amount (F) may any value less than or equal to the FDIC deposit insurance limit of $250,000 USD. Further to the previous example, in some processes, the maximum allowable sweep amount (F) may be equal to $240,000 USD. It should be appreciated that the eligible decrement amount (N_{A}) and/or the account level sweep amount (LA) may be less than the maximum allowable sweep amount (F). However, it should also be appreciated that the maximum allowable sweep amount (F) may not be based upon the government provided deposit insurance limit and may instead be based upon a private deposit insurance limit. For example, the account holder may carry a separate private insurance policy on their account, which effectively raises their deposit insurance limit above the government provided limit. In this circumstance, the maximum allowable sweep amount (F) may be based upon the private deposit insurance limit, such that the maximum allowable sweep amount (F) is less than or equal to the private deposit insurance limit.

Returning to the discussion of step 402, today's minimum required account balance (P_{Today}) may be described as the difference between the available balance (X) and the eligible decrement amount (N_{A}), or P_{Today}=−N_{A}). However, it should be appreciated that step 402 may be a difference between any previous post sweep balance (Q) and any minimum required account balance (P), assuming the minimum required account balance (P) comes later in time, or after, the previous post sweep balance (Q). For example, in step 402 the load-balanced application server 1014 may determine a difference between a post sweep balance from five days ago (Q_{FiveDaysAgo}) and a minimum required account balance from three days ago (P_{ThreeDaysAgo}).

Upon a determination that yesterday's post sweep balance (Q_{Yesterday}) is less than today's minimum required account balance (P_{Today}), the process may include the load-balanced application server 1014 determining the participating institution that has the highest deposit fee and adjusting a record to remove a value of (P_{Today}−Q_{Yesterday}) from the participating institution until the value of the delta account balance (B) of the first account is equal to a value of zero (at step 408). However, it should be appreciated that the value can be a difference between any minimum required account balance (P) and any previous post sweep balance (Q). For example, the process may adjust a record and remove a value of (P_{Yesterday}−Q_{ThreeDaysAgo}) from the participating institution.

Alternatively, if the process determines that yesterday's post sweep balance (Q_{Yesterday}) is not less than today's minimum required account balance (P_{Today}), the process may include the load-balanced application server 1014 determining a delta minimum account balance (E) of the first account (at step 410). The delta minimum account balance (E) may represent an amount of values that are eligible to sweep from the first account. Stated differently, the delta minimum account balance (E) may be described as the difference between yesterday's post sweep balance (Q_{Yesterday}) and today's minimum required account balance (P_{Today}), or E=(Q_{Yesterday}−P_{Today}). Similar to step 402, it should be appreciated that the delta minimum account balance (E) may be equal to the difference between any previous post sweep balance (Q) and any minimum required account balance (P), assuming the minimum required account balance (P) comes later in time, or after, the previous post sweep balance (Q).

Upon a determination that the delta minimum account balance (E) of the first account is less than the delta account balance (B), the process may include adjusting a record in the database cluster server 1008 to lower the delta minimum account balance (E) to a value of zero and adjusting a record to remove a value equal to the difference of the delta account balance (B) and the delta minimum account balance (E), or (B−E) from the participating institution with the highest deposit fee (at step 412). It should be appreciated that if there are at least two or more highest deposit fees that are equal in value, then the process may include the load-balanced application server 1014 selecting the participating institution, of the participating institutions associated with the two or more highest deposit fees, with the highest account level sweep amount (J_{nA}). Step 412 may be followed by step 314, previously discussed.

Upon a determination that the delta minimum account balance (E) of the first account is greater than or equal to the delta account balance (B), the process may include adjusting a record in the database cluster server 1008 to subtract the delta account balance (B) from the delta minimum account balance (E), to create a new lower delta minimum account balance (E) for the sweep (at step 414). Step 414 may be followed by step 314, as already discussed.

In regards to the example process illustrated in FIG. 6, upon a determination that the delta account balance (B) is greater than zero, the process may include adjusting a record in the database cluster server 1008 to add the first account to the sweep database, which may indicate that the first account is eligible for an upcoming sweep (at step 404). The step at 404 may include the load-balanced application server 1014 querying the plurality of first accounts to determine a next first account with a delta account balance (B) that is greater than zero. Alternatively, upon a determination that the delta account balance (B) of the first account is equal to zero, the process may include querying the plurality of first accounts to determine a delta account balance (B) of a next first account (at step 406). Steps 404 and 406 may each be followed by step 314, as previously discussed.

FIG. 7 illustrates an example process for determining a supply and demand of deposits to sweep from one or more first accounts to one or more participating institutions. The process may include the load-balanced application server 1014 determining a requested sweep amount (M), a received sweep amount (H), and a required sweep amount (S) for each of the one or more participating institutions that are enabled to participate in the sweep program (at step 500). The process may include determining whether the required sweep amount (S) is greater than zero for any of the participating institutions (at step 502). This may serve as an indication that at least one participating institution is still in need of deposits to satisfy, or reach, its requested sweep amount (M).

While step 500 may determine all sweep amounts including the requested sweep amount (M), the received sweep amount (H), and the required sweep amount (S) for each of the one or more participating institutions, other embodiments may only determine one or more of the sweep amounts. For example, another embodiment may only have the load-balanced application server 1014 determine the required sweep (S) of each of the one or more participating institutions, while yet another embodiment may only determine the received sweep amount (H) of each of the one or more participating institutions.

Upon a determination that no participating institution has a required sweep amount (S) that is greater than zero, the process may include adjusting a record in the database cluster server 1008 to update any variables, such as available balance (X), etc. (at step 504). The step at 504 may include recording the updated variables for archiving and/or reporting purposes. It should be appreciated that recording may comprise taking a snapshot of the updated variables, or any other suitable recording process, and storing the data.

Alternatively, upon a determination that at least one participating institution has a required sweep amount (S) that is greater than zero, the process may include determining an order of eligible first accounts (at step 506). It should be appreciated that the eligible first accounts may be referred to as a sweep queue. For example, the eligible first accounts may be ranked by the delta minimum account balances (E) of each respective first account. For example, the queue may rank the eligible first accounts from highest to lowest delta minimum account balance (E), lowest to highest (E), or the like. It should also be appreciated that the eligible first accounts may be ranked by any other variable described in this disclosure, for example, in some embodiments the eligible first accounts may be ranked by their eligible decrement amounts (N_{A}).

The process may include subjecting the eligible first accounts to additional conditions. For example, the process may order the eligible first accounts, of the sweep queue, having the highest to lowest delta minimum account balance (E) of those eligible first accounts having TIN level total sweep amounts (J_{nT}) that are less than the maximum allowable sweep amount (F). It should also be appreciated that the eligible first accounts, of the sweep queue, may be ordered (or ranked) according to multiple conditions. For example, the process may order the eligible first accounts, of the sweep queue, by the delta minimum account balances (E) of those eligible first accounts having TIN level total sweep amounts (J_{nT}) that are less than the maximum allowable sweep amount (F) and of those eligible first accounts having available balances (X) higher than a predetermined amount.

It should be appreciated that the process may include additional queues of first accounts, such as a new account queue, a carryover queue, or the like. The process may comprise any variety of queues that list first accounts according to any such desired criteria. For example, a new account queue may comprise a list of eligible first accounts that have never before been swept, but are now eligible to participate in the sweep program. In some examples, the eligible first accounts, of the new account queue, may be ordered by their respective eligible decrement amounts (N_{A}) of the first accounts listed within the new account queue. However, it should be appreciated that the new account queue may be ordered according to any variable described in this disclosure.

As well, the process may include steps to compare one or more variables of various queues against one another. For example, the process may include the load-balanced application server 1014 selecting a highest required sweep amount (S) of a select participating institution and determining whether the select required sweep amount (S) is greater than or equal to a highest eligible decrement amount (N_{A}) of the first select deposit account. Upon a determination that the select required sweep amount (S) of the select participating institution is greater than or equal to the highest eligible decrement amount (N_{A}) of the first select deposit account, the process may include sweeping the highest eligible decrement amount (N_{A}) of the first select noninterest-bearing deposit account to a noninterest-bearing account of the select participating institution. Alternatively, upon a determination that the select required sweep amount (S) of the select participating institution is not greater than or equal to the highest eligible account level sweep amount (N_{A}) of the first select deposit account, the process may include sweeping an actual sweep amount (J_{nA}) to the select account of the select participating institution. In this manner, the actual sweep amount (J_{nA}) may be less than or equal to the required sweep amount (S). Alternatively stated, the selected eligible decrement amount (N_{A}) to sweep may be less than or equal to the calculated difference between a requested amount of deposits requested by a second institution from the first institution and a received amount of deposits received by the second institution from the first institution.

The process may include the load-balanced application server 1014 determining whether a TIN level sweep amount (J_{nT}) associated with each first account and for each participating institution is equal to a maximum allowable sweep amount (F) (at step 508). Upon a determination that a TIN level sweep amount (J_{nT}) associated with each first account and for each participating institution is equal to a maximum allowable sweep amount (F), the process may include adjusting a record to add a noninterest-bearing first account to a carryover queue (at step 510). This may indicate that the first account still includes deposits that are eligible to be swept from the first account, yet the selected participating institution is no longer eligible to receive deposits from this first account because the associated TIN level sweep amount (J_{nT}) is equal to the maximum allowable sweep amount (F).

The process may include the load-balanced application server 1014 determining a next first account (at step 512). It should be appreciated that the carryover queue of eligible first accounts can be ordered (or ranked) in the same way as previously described with regards to the sweep queue of eligible first accounts. Alternatively, the carryover queue can be ranked according to different criteria from the sweep queue. For example, the eligible first accounts of the sweep queue could be ranked by the delta minimum account balance (E), while the first accounts of the carryover queue could be ranked by their available balances (X), or any other such variable. In general, it should be appreciated that either the sweep queue or the carryover queue can be ordered by any variable described in this disclosure.

With continued reference to FIG. 7, upon a determination that a TIN level sweep amount (J_{nT}) associated with each first account and for each participating institution is not equal to a maximum allowable sweep amount (F), the process may include the load-balanced application server 1014 sweeping values from the first account until the TIN level sweep amount (J_{nT}) is equal to the maximum allowable sweep amount (F), until the delta minimum account balance (E) of the first account equals zero (at step 524), or until the swept amount equals the difference between the requested amount of deposits and the received amount of deposits. If the delta minimum account balance (E) of the first account equals zero, then the process may continue with step 512. Alternatively, if the TIN level sweep amount (J_{nT}) associated with the first account equals the maximum allowable sweep amount (F), then the process may include flagging the first account as having reached the maximum allowable sweep amount (F) at the participating institution that is currently receiving sweep deposits from the first account (at step 526).

The process may include the load-balanced application server 1014 determining whether this is the last account with a delta minimum account balance (E) that is greater than zero (at step 514). Upon a determination that this is not the last account with a delta minimum account balance (E) that is greater than zero, the process may include determining a next first account (at step 516). Step 516 may be followed by step 508, as already discussed.

Upon a determination that this is the last account with a delta minimum account balance (E) that is greater than zero, the process may include the load-balanced application server 1014 determining whether this is the last participating institution (at step 518). Upon a determination that this is not the last participating institution, the process may include determining another participating institution (at step 520). The step 520 may include determining the one or more first accounts in the carryover queue. The step 520 may be followed by the step of ordering the one or more first accounts by their respective delta minimum account balance (E), as described in step 506.

In the event that this is the last participating institution, the process may include determining whether a required sweep amount (S) equals zero at all participating institutions (at step 522). Upon a determination that the required sweep amount (S) equals zero at all participating institutions, this may indicate that all participating institutions have received all requested sweep amounts (M), and thus do not require any additional deposits. In this circumstance, the process may include the step described at 504. Alternatively, upon a determination that the required sweep amount (S) does not equal zero at all participating institutions, this may indicate that one or more participating institutions need additional sweep deposits.

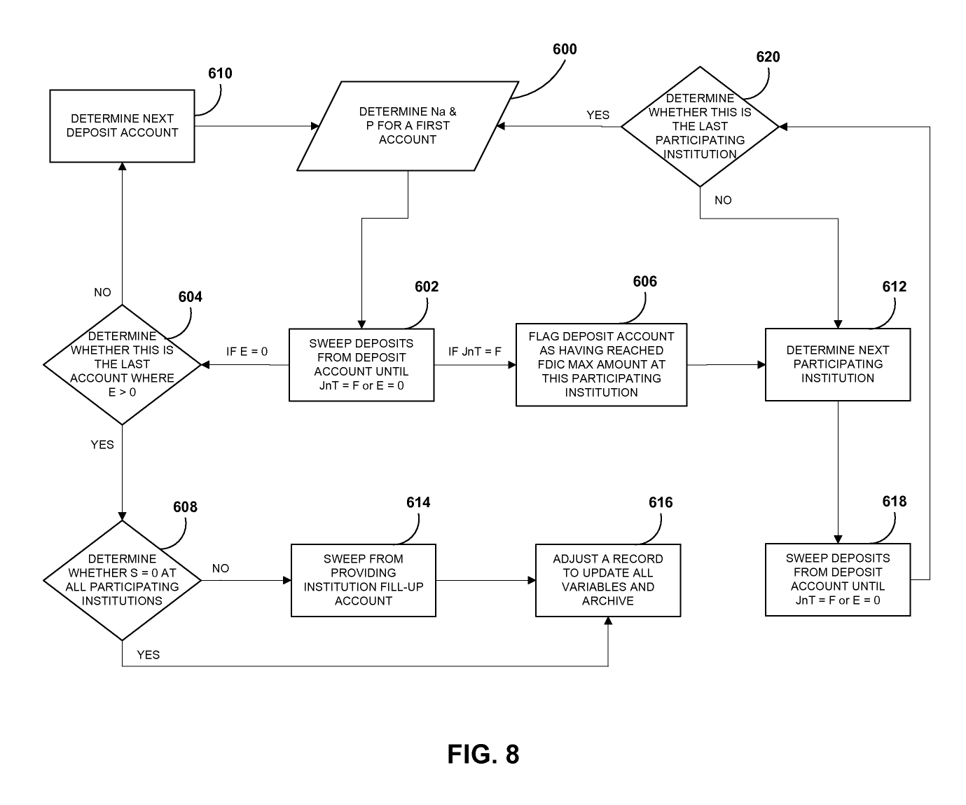

FIG. 8 illustrates additional steps for sweeping values from a providing institution. The example process shown in FIG. 8 may include the load-balanced application server 1014 determining an eligible decrement amount (N_{A}) and a minimum required account balance (P) for a noninterest-bearing first account (at step 600). The process may include the load-balanced application server 1014 sweeping deposit values from a noninterest-bearing first account until a TIN level sweep amount (J_{nT}) associated with the first account equals the maximum allowable sweep amount (F) or until a delta minimum account balance (E) associated with the first account equals zero (at step 602). In some processes, the deposit values may be swept from a noninterest-bearing first account maintained by a providing institution to a noninterest-bearing second account, or the like account, maintained by a participating institution. However, it should be appreciated that the process may include sweeping values between any number of accounts, such as a noninterest-bearing first account, a noninterest-bearing second account, a noninterest-bearing third account, a noninterest-bearing fourth account, etc.

If the delta minimum account balance (E) of the first account equals zero, then the process may include the load-balanced application server 1014 determining whether this is the last account where a delta minimum account balance (E) is greater than zero (at step 604). Upon a determination that this is not the last account where a delta minimum account balance (E) is greater than zero, the process may include determining a next deposit account in the database cluster server 1008 (at step 610), to repeat the process illustrated in FIG. 8. As such, step 610 may be followed by step 600, or determining an eligible decrement amount (N_{A}) and a minimum required account balance (P) for a noninterest-bearing first account.

Alternatively, upon a determination that this is the last account where a delta minimum account balance (E) is greater than zero, the process may include the load-balanced application server 1014 determining whether all required sweep amounts (S) equal zero for each of the participating institutions (at step 608). In other words, if all participating institutions have respective required sweep amounts (S) equal to zero, then the demand for swept deposits from a providing institution to participating institutions is zero and the sweep may be complete. Upon a determination that all required sweep amounts (S) are equal to zero for all participating institutions, the process may include adjusting a record to update all variables in the database cluster server 1008 for archiving and/or reporting purposes (at step 616). However, upon a determination that all required sweep amounts (S) are not equal to zero for all participating institutions, the process may include the load-balanced application server 1014 sweeping from a providing institution (at step 614). In this scenario, there still may be a demand for swept deposits at participating institutions; however, the first accounts at a providing institution may not contain a supply of deposits that matches the demand by the participating institutions. As such, the providing institution may supply the demand by sweeping values from another account, such as a fill-up account. In this manner, it should be appreciated that the fill-up account may comprise values to be swept to a participating institution when the providing institution cannot satisfy the required sweep amount (S) from its eligible first accounts. It should also be appreciated that the fill-up account may be treated like any other first account. In that regard, the fill-up account may undergo any of the steps described within this disclosure. For example, the fill-up account may be subject to a maximum allowable sweep amount (F). Additionally, step 614 may be followed by step 616, as previously described.

Upon a determination that the TIN level sweep amount (J_{nT}) equals the maximum allowable sweep amount (F), the process may include flagging the first account has having reached the maximum allowable sweep amount (F) at the associated participating institution (at step 606). As well, the process may include the load-balanced application server 1014 determining a next participating institution, wherein the TIN level sweep amount (J_{nT}) does not equal the maximum allowable sweep amount (F) (at step 612). Upon determining such an institution, the process may include sweeping values from the first account until the TIN level sweep amount (J_{nT}) equals the maximum allowable sweep amount (F) or until the delta minimum account balance (E) equals zero (at step 618). The process may determine whether this is the last participating institution (at step 620). Upon a determination that this is the last participating institution, the process may continue at step 600, as previously discussed. Alternatively, upon a determination that this is not the last participating institution, the process may continue at step 612.

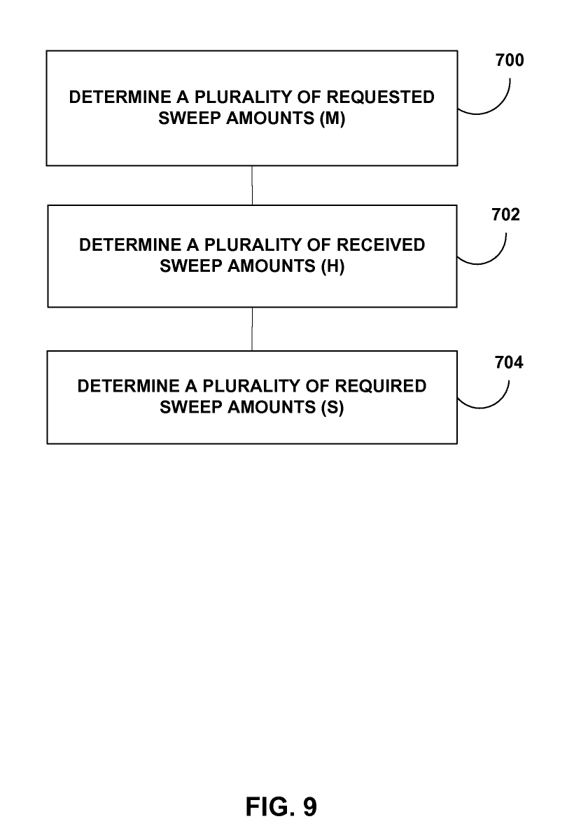

FIG. 9 illustrates a process of determining the required demand of one or more participating institutions to receive swept deposits. The process may include the load-balanced application server 1014 determining a plurality of requested sweep amounts (M) (at step 700). A requested sweep amount (M) of the plurality of requested sweep amounts (M) may be an amount of deposits that a participating institution requests from one or more providing institutions, and vice versa. In this manner, the one or more providing institutions may determine a supply and demand of deposits to sweep. The demand may be the plurality of requested sweep amounts (M) from one or more participating institutions, while the supply may be a plurality of threshold data values that are eligible to be swept from the plurality of deposit accounts.

The process may include the load-balanced application server 1014 determining a plurality of received sweep amounts (H) (at step 702). A received sweep amount (H) of the plurality of received sweep amounts (H) may be an amount of deposits that a participating institution (e.g. a second institution, a third institution, etc.) has received from one or more providing institutions (e.g. a first institution), and vice versa. Moreover, the plurality of received sweep amounts (H) may be referred to as the satisfied demand.

With continued reference to FIG. 9, the process may include the load-balanced application server 1014 determining a plurality of required sweep amounts (S) (at step 704). A required sweep amount (S) of the plurality of required sweep amounts (S) may be an amount of deposits that a participating institution requires in order to reach the participating institutions total requested sweep amount (M). In this manner, the required sweep amount (S) may be the difference between the requested sweep amount (M) and the received sweep amount (H), or simply: S=(M−H). The plurality of required sweep amounts (S) corresponding to the plurality of participating institutions may be known as the required sweep amount queue. It should also be appreciated that a plurality of requested sweep amounts (M) of participating institutions may be known as the requested sweep amount queue. Accordingly, a plurality of received sweep amounts (H) of participating institutions may be known as the received sweep amount queue. As well, it should be appreciated that any of the sweep amounts within any of the queues may be ranked in any order, for example, from highest to lowest, lowest to highest, or the like.

It should be appreciated that the process illustrated in FIG. 9 may include additional steps to determine any of the variables described in this disclosure. For example, the process of FIG. 9 may include the load-balanced application server 1014 determining: a maximum allowable sweep amount (F), a present available balance (X_{Today}), a present eligible account level sweep amount (N_{A,Today}), a present required remaining account balance (P_{Today}) of the first account, a previous available balance (X_{Yesterday}) the first account, a previous eligible account level sweep amount (N_{A,Yeterday}), a previous required remaining account balance (P_{Yesterday}) the first account, a previous post sweep balance (Q_{Yesterday}) of the first account, a delta minimum account balance (E) of the first account, and/or a delta account balance amount (B) of the first account. It should further be appreciated that any or all of these variables may be used by the load-balanced application server 1014 to determine a sweep amount. For example, the load-balanced application server 1014 may calculate and/or select an eligible decrement value (N_{A}) that is equal to a difference between a present balance value (X_{Today}) of the first electronic account and a previous balance value of the first electronic account. It should be appreciated that this difference may be a difference between the present balance value (X_{Today}) and a previous value chosen over any period of time, such as yesterday's available balance (X_{Yesterday}) or an available balance from three days ago (X_{ThreeDaysAgo}). It should also be appreciated that a selected previous balance value may be greater than, less than, or equal to the balance value (x) of the first electronic account after a last sweeping, or decrementing, has occurred.

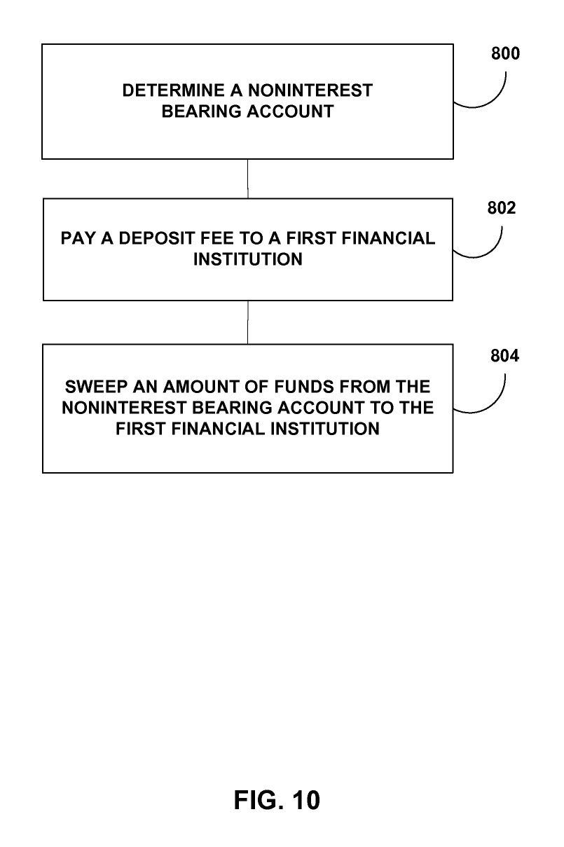

FIG. 10 illustrates a process of sweeping values back from a noninterest-bearing account to a first institution. As such, the process may include the load-balanced application server 1014 determining a noninterest-bearing account (at step 800). In some embodiments the account is maintained by a second institution. For example, the process may include the load-balanced application server 1014 querying a database in the database cluster server 1008 to identify a first electronic account associated with a second institution, the balance value of the first electronic account comprising electronic deposits that have been decremented from respective balance values of at least one electronic account of the first institution and incremented to the balance value of the first electronic account. In other embodiments, the account is maintained by a first institution, a third institution, or any institution capable of maintaining a noninterest-bearing account.

The process may also include paying a deposit fee to the first institution, or providing institution (at step 802). The deposit fee may be determined by the load-balanced application server 1014 by any suitable process. In some embodiments, the deposit fee may be determined or calculated based upon the balance value of the electronic account, the balance value comprising deposits previously swept to the electronic account at the participating institution. For example, the deposit fee may be a percentage of the actual amount swept to the participating institution. In some examples, the deposit fee may be determined by the participating institution's access to deposits. For instance, if participating institution A has a limited access to deposits, perhaps because the participating institution A does not have enough assets on its books or perhaps because it does not have relationships established with other providing institutions to supply the needed deposit values, then the participating institution A may pay a higher or lower deposit fee to the providing institution depending on institution A's access to deposits. However, it should be appreciated that the providing institution may assess a higher or lower deposit fee based upon any variety of factors. For example, the providing institution may assess a higher deposit fee for participating institutions that have high ratings for some things versus others. In some examples, the providing institution may charge a lower deposit fee to a participating institution that receives a larger amount of deposit values, as compared to another participating institution that receives a smaller amount deposit values.

It should also be appreciated that the load-balanced application server 1014 of the providing institution may adjust the order that the providing institution deposits and/or withdraws values to/from participating institution(s). In some examples, the order is determined by the first participating institution in and last participating institution out by deposit fee. In other words, the providing institution may first deposit and/or withdraw values to/from the participating institution paying the providing institution the lowest amount, followed by the next providing institution paying the second lowest amount, etc. It should also be appreciated that the providing institution may first deposit and/or withdraw values to/from the participating institution paying the providing institution the highest amount, followed by the next providing institution paying the second highest amount, etc.

In another example of sweeping from a participating institution to a providing institution, the load-balanced application server 1014 determines that a requested amount of deposits requested by a second institution from the first institution is less than the received amount of deposits received by the second institution from the first institution, which may be performed by identifying that the difference between the requested amount of deposits and the received amount of deposits is negative. Upon determining this, the load-balanced application server 1014 may query the database cluster server 1008 to select a second electronic account from the plurality of electronic accounts wherein the second account is associated with the second institution and pays a greatest deposit fee to the first institution. After identifying the second account, the process includes updating the database to decrement at least the selected eligible decrement value from the balance value of the second electronic account and updating the database to increment both the balance value of a first electronic account associated with the first institution and the institutional value of the balance sheet by the amount decremented from the balance value of the second electronic account. However, these are just a few of many examples of how the providing institution may deposit and/or withdraw values to/from the participating institution(s).

As well, the process may include receiving instructions from a first institution to establish a noninterest-bearing account. It should be appreciated that the account may be referred to as a noninterest-bearing first account and may be stored in the database cluster server 1008. The process may include receiving a request to close the first account. And in accordance with the request to close the first account, the process may include the step of closing the first account. It should be appreciated that the receiving instructions may be received by a second institution, a third institution, or the like. As well, the established first account may be established at the second institution, the third institution, the first institution or any other suitable institution capable of maintaining a noninterest-bearing account. The process may include receiving a request to sweep deposit values back to the first institution. The deposit values may comprise a portion or all of the available balance (X) of the established first account. It should be appreciated that the available balance (X) of the first account may receive the benefit of FDIC insurance coverage. It should further be appreciated that the load-balanced application server 1014 may query the database to identify a second electronic account associated with the second institution, wherein the second electronic account holds the balance values to be swept from the second institution to the first institution. In this manner, the balance values to be used for sweeping are separate from those originally swept from the first institution to the second institution. This second electronic account may be an electronic omnibus account.

The process may include the load-balanced application server 1014 sweeping an amount of values from the account to the first institution (at step 804). Timing of the sweeping from the second account may be based on the electronic deposit fee paid by the second institution to the first institution, the paying of which may be made at a predetermined interval and via an automated clearing house payment or a Fedwire payment. In an exemplary embodiment, the load-balanced application server 1014 may perform the following actions after querying the database for a second electronic account of the second institution to complete the sweeping process from the second institution: querying the database to identify a third electronic account of the first institution; updating the database to decrement at most the electronic deposit fee from the balance value of the second electronic account at a time based upon the electronic deposit fee paid by the second institution to the first institution; and updating the database to increment both the balance value of the third electronic account and the institutional value of the balance sheet by the amount decremented from the balance value of the second electronic account. For example, if a plurality of institutions is paying deposit fees to the first institution, the order of the sweeping of each of the plurality of institutions may be determined by each deposit fee paid from each of the institutions to the first institutions, such as the greatest deposit fee of a plurality of deposit fees being swept first. It should also be appreciated that the order of the plurality of institutions may be ranked in any order based on the deposit fees. For example, the order may be from highest to lowest, lowest to highest, or the like. As such, if a second institution deposit fee is greater than a third institution deposit fee, the process may include the first institution sweeping from the second institution before the first institution sweeps from the third institution. In this example, if a third institution deposit fee is greater than a second institution deposit fee, the process may include the first institution sweeping from the third institution before the first institution sweeps from the second institution. More specifically, the load-balanced application server 1014 would query the database to identify accounts associated with the second institution instead of a third institution based upon the second institution paying a greater electronic deposit fee to the first institution than the third institution.

In some examples, the second institution deposit fee may be equal to the third institution deposit fee. As previously discussed, the second institution may have a noninterest-bearing second account level sweep amount (J_{nA2}) and the third institution may have a noninterest-bearing third account level sweep amount (J_{nA3}). Accordingly, the process may include determining which is greater, the second account level sweep amount (J_{nA2}) or the third account level sweep amount (J_{nA3}). Upon a determination that the second account level sweep amount (J_{nA2}) is greater than the third account level sweep amount (J_{nA3}), the process may include sweeping (or removing) an amount of values from a record of the second institution so that a previous post sweep balance (Q_{Yesterday}) is equal to a present required remaining account balance (P_{Today}). It should be appreciated that the amount of values in this circumstance may equal [|B|−(P_{Yesterday}−P_{Today})]. Alternatively, upon a determination that the third account level sweep amount (J_{nA3}) is greater than the second account level sweep amount (J_{nA2}), the process may include sweeping (or removing) an amount of values from a record of the third institution so that a previous post sweep balance (Q_{Yesterday}) is equal to the present required remaining account balance (P_{Today}).

In some embodiments, the load-balanced application server 1014 sweeping of the deposit fee may occur directly from the second institution to the first institution, i.e. without incrementing the balance value or decrementing the balance value of a fourth electronic account. In other embodiments, the electronic deposit fee may be swept indirectly from the second institution to the first institution. In these embodiments, the process of updating the database to decrement at most the electronic deposit fee from the balance value of the second electronic account at a time based upon the electronic deposit fee paid by the second institution to the first institution would comprise: updating the database to decrement at most the electronic deposit fee from the balance value of the second electronic account at a time based upon the electronic deposit fee paid by the second institution to the first institution; querying the database to identify another electronic account; updating the database to increment the balance value of the another electronic account by at most the amount decremented from the balance value of the second electronic account; and updating the database to decrement the balance value of the another electronic account by the amount incremented to the balance value of the another electronic account.

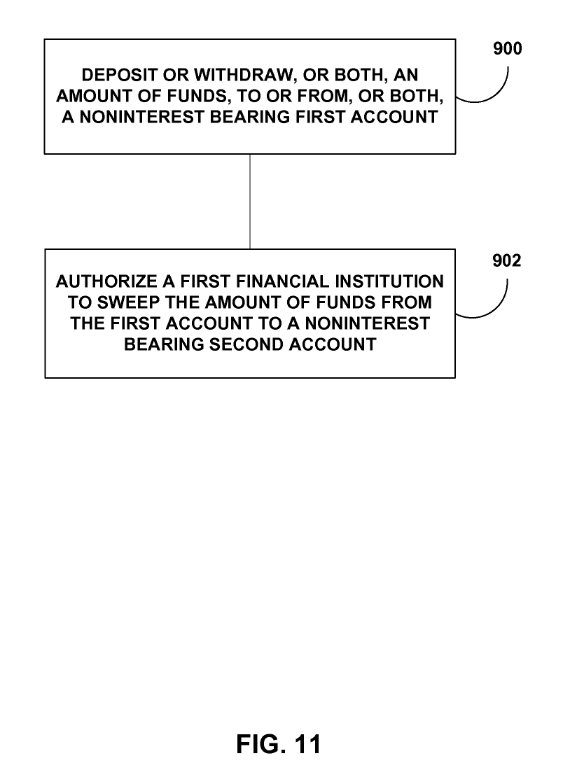

FIG. 11 illustrates a process of a noninterest-bearing first account holder participating in a sweep program. The process may include depositing or withdrawing values, or both, to or from, or both, a noninterest-bearing first account (at step 900). It should be appreciated that the first account may be maintained by the first account holder. As well, the first account may be maintained by a first institution, a second institution, a third institution, or any institution capable of maintaining such account. The process may include authorizing a first institution to sweep an amount of values from the first account to a noninterest-bearing second account (at step 902). It should be appreciated that the second account may be maintained by the second institution, the first institution, the third institution, or institution capable of maintaining a noninterest-bearing account.

It should be appreciated that the first account may comprise and/or have access to non-swept values (Q) that are still remaining in the first account, swept values (Q_{Swept}) that have been swept from first account, and total available values (X). Thus, it should be appreciated that in some embodiments X=(Q+Q_{Swept}). It should also be recognized that the process may include receiving the benefit of FDIC insurance coverage on the non-swept values (Q), the swept values (Q_{Swept}), and/or the total available values (X).

With continued reference to FIG. 11, the process may include the step of opting in and/or opting out of participating in the sweep program. It should be appreciated that the opting in and/or opting out process may comprise a noninterest-bearing first account holder checking and/or unchecking a box on a web interface, which may enable and/or disable the first account from participating in the sweep program. As well, it should be appreciated that the opting in and/or opting out may be accomplished any number of ways, for example, in one embodiment a noninterest-bearing first account holder may contact a participating institution via telephone and communicate to an agent that the first account should be enabled and/or disabled from participating in the sweep program. In another example, accounts may automatically be subject to enrollment in the sweep program, and an account holder must contact the bank to opt out of the program. These are just some of the many examples of how the first account may be opted in and/or opted out of participating in the sweep program.

While not illustrated, the disclosure may include processes of evaluating performance of a first institution, a second institution, a third institution, and/or the like. It should be appreciated that the evaluating step can include any number of steps to evaluate the performance of participation in the sweep program. For example, in some embodiments the process may evaluate the performance from a providing institution perspective (e.g. a first institution), and the process may include determining a plurality of deposit fees received from a plurality of participating institutions. The process may include determining, amongst the plurality of participating institutions, which participating institution has paid the highest amount of deposit fees to a first institution. As well, the process may include determining, amongst the plurality of participating institutions, which participating institution has averaged paying the highest deposit fee per unit of deposits received from the first institution.

The process may include steps for evaluating performance from a participating institution perspective (e.g. a second institution, a third institution, etc.). For example, the process may include the load-balanced application server 1014 determining a deposit fee that is paid to a providing institution and determining whether the deposit fee is greater than or less than at least a second deposit fee paid to another providing institution. This may allow the participating institution to determine how and where to receive deposit values from providing institutions and accordingly, pay deposit fees to corresponding providing institutions.

It should also be appreciated that the providing institution may track performance of one or more participating institutions. In some examples, the providing institution may determine and/or analyze metrics, such as: nonperforming assets (i.e. asset quality), capital (FDIC classifications, and/or detailed segments like Tier I, Total Capital etc.), liquidity, or any metric that can be monitored by an institution. It should also be appreciated that the participating institution may also monitor the performance of the providing institution by determining and/or analyzing any such metric.

While the foregoing description and drawings represent at least one embodiment of the sweep program, it will be understood that various additions, modifications, combinations and/or substitutions may be made therein without departing from the spirit and scope of the example embodiments as defined in the accompanying claims. In particular, it will be clear to those skilled in the art that the example embodiments may be embodied in other specific forms, structures, arrangements, proportions, and with other elements, materials, and components, without departing from the spirit or essential characteristics thereof. One skilled in the art will appreciate that the example embodiments may be used with many modifications of structure, arrangement, proportions, materials, and components, which are particularly adapted to specific environments and operative requirements without departing from the principles of the example embodiments. In addition, features or steps described herein may be used singularly or in combination with other features or steps. For example, features or steps described in connection with one component may be used and/or interchanged with features or steps described in another component or process. The presently disclosed embodiment is therefore to be considered in all respects as illustrative and not restrictive, the scope of the example embodiments being indicated by the appended claims, and not limited to the foregoing description.

It will be appreciated by those skilled in the art that various modifications and alterations of the example embodiments can be made without departing from the broad scope of the appended claims. Some of these have been discussed above and others will be apparent to those skilled in the art.

### Additional Illustrative Embodiments

The following is an example of how the disclosed systems may be used to transfer funds via Fedwire between a providing institution and a participating institution. For purposes of this example, Bankco is the providing institution and participating institutions are banks participating in the sweep program. An actual transfer may only take place when one of the following occurs: a new participating bank joins the sweep program, thereby creating a need for funding; an existing participating bank's funding needs increase; or an existing participating bank's funding needs decrease, thereby requiring the system to decrement all or a part of the funding at that institution and increment funds at Bankco.

On days not including wiring of funds, the incrementing/decrementing occurs purely in Bankco's database. For example, Jeff had $1,000 at Bankco—of that, $800 was actually on Bankco's balance sheet and $200 was swept. Erin had $1,000 at Bankco, none of which was swept. Jeff pays a bill and sends $900 out of his Bankco account. During the sweep process, the system replaces his $100 that Bankco must pull back from the participating bank with Erin's funds. The system then decrements his swept deposits in the participating bank by $100 and increments his “at Bankco” balance by $100. At the same time, the system decrements Erin's Bankco balance by $100 and increments Erin's holding in the participating by $100. Bankco's balance sheet has a net change of $0, as does the overall balance of the account at the participating bank.

On days Bankco transfers funds, i.e., days including one of the 3 situations described above, the incrementing/decrementing actually changes the overall balance of the participating bank account, requiring physical movement of funds.

The following example entails days when a new participating bank joins the sweep program. Participating Bank A is brand new and has a funding request of $2,000. Jeff and Erin each have $1,000 balances at Bankco, and the system has fully swept each account to Bank A. In addition to decrementing Jeff's and Erin's respective Bankco balances and incrementing Jeff's and Erin's respective Bank A balances in the database, the system also performs the following. After the system determines the total amount to be sent to Bank A, it decrements a Bankco institutional account by $2,000—this is an account that holds a negative balance equal to the totality of funds swept off of Bankco's balance sheet—and increments the $2,000 to a Bankco omnibus “clearing account” out of which the wire is sent. The system sends a file to a non-proprietary Fedwire system called. That file is sent automatically, based on a scheduled job, and contains information including the amount of the wire ($2,000), the account number of the clearing account at Bankco, Bankco's ABA/routing number, the name, address, and ABA/routing number of the Participating Bank, and Bankco's account number at the participating Bank. The Fedwire system loads the information from that file and generates a Fedwire. The wired transfer is then released, manually, via computer, or otherwise, to the Federal Reserve, which routes the wire to the Participating Bank and to Bankco's account, using the information the system provided in the wire file. The Participating Bank also has a Fedwire system which receives the incoming wire and credits Bankco's omnibus account.

The following example entails days when an existing participating bank's funding needs increase. Participating Bank A increases its funding needs to $3,000. Jeff and Erin had no balance change, but Lesley and Andrew have accounts at Bankco with $500 balances that were not previously swept. The system proceeds exactly as it did in the previous example, but this time wiring $1,000 to Bank A. Again, the Bankco institutional account is decremented for the $1,000 (so, assuming Bank A is the only participating bank, the Bankco institutional account now holds a −$3,000 balance), the clearing account is incremented the $1,000, and the Fedwire system uses the information the system provides to debit the clearing account for the $1,000 and send the wire to Bank A, which deposits it, resulting in Bankco's account at Bank A having a $3,000 balance value.

Further, the Bankco institutional account balance and clearing account balance movements are visible at the institutional level, which is different from all of the intra-database decrementing and incrementing. The system is actually interacting with Bankco's non-proprietary core processor to effect these funds movements. The Fedwire system, when it sends the wire, interfaces with Banco's core processor to debit the wire amount from the clearing account and send the wire. The clearing account should be $0 after settlement each day.

The following example entails days when an existing participating bank's funding needs decrease. Bank A chooses to not participate any further in the sweep program. In this case, the system decrements the holdings of Jeff, Erin, Lesley, and Andrew from Bank A and increments their respective deposit accounts at Bankco, comprising database movements. The system then creates a wire file and sends the Fedwire system the same information about Bankco and Bank A, with instructions to do a reverse wire. The Fedwire system then sends the wire message to the Federal Reserve, which sends the wire message on to Bank A. Bank A responds by sending the $3,000 to the clearing account at Bankco. The system schedules a job to look for the expected funding in the clearing account, and when the system sees the funds, the system decrements the clearing account to $0 and increments the Bankco institutional account with a positive $3,000, reflecting funds being once again present on Bankco's balance sheet. Again, Bankco institutional account and clearing account movement of funds are visible at an institutional level.

What is claimed:

1. A system comprising:
a database cluster server comprising:
a first computing memory storing a balance sheet and a first plurality of electronic accounts, the balance sheet including at least an institutional value, each of the first plurality of electronic accounts comprising a plurality of data parameters including at least a balance value not accruing interest, a ledger sheet having an available-balance value initialized to the balance value, and an eligible decrement value; and
a second computing memory storing a second plurality of electronic accounts, each of the second plurality of electronic accounts comprising a plurality of data parameters including at least a balance value not accruing interest, a ledger sheet having an available-balance value initialized to the balance value, and an eligible decrement value; and
a load-balanced application server communicatively connected to the database cluster server, the load-balanced application server having stored thereon computer instructions that during execution cause the system to perform operations comprising:
querying the first computing memory for a first electronic account of the first plurality of electronic accounts;
calculating a threshold data value of the first electronic account based on one of the plurality of data parameters associated with the first electronic account;
comparing a balance value associated with the first electronic account to the threshold data value;
upon identifying that the balance value of the first electronic account exceeds the threshold data value:
querying the second computing memory for a second electronic account of the second plurality of electronic accounts;
decrementing the balance value of the first electronic account and the institutional value of the balance sheet by a pre-selected amount without changing the available-balance value of the ledger sheet associated with the first electronic account; and
incrementing the balance value of the second electronic account by the pre-selected amount.

2. The system of claim 1, wherein the threshold data value is equal to a value of zero.

3. The system of claim 1, wherein the pre-selected amount is equal to the balance value of the first electronic account.

4. The system of claim 1, wherein a deposit fee is associated with incrementing the balance value of the second electronic account.

5. The system of claim 1, wherein the first electronic account is associated with a providing institution and the second electronic account is associated with a participating institution.

6. The system of claim 1, wherein the first electronic account is maintained by a providing institution and the second electronic account is maintained by a participating institution.

7. The system of claim 1, the load-balanced application server having stored thereon computer instructions that during execution cause the system to perform operations further comprising:
querying the second computing memory for a third electronic account of the second plurality of electronic accounts;
decrementing the balance value of the first electronic account and the institutional value of the balance sheet by a pre-selected amount without changing the available-balance value of the ledger sheet associated with the first electronic account; and
incrementing the balance value of the third electronic account by the pre-selected amount.

8. The system of claim 7, wherein the third electronic account is associated with a third institution.

9. A system comprising:
a computing memory having a database stored therein, the database storing a balance sheet and a plurality of electronic accounts, the balance sheet being associated with a first institution and including at least an institutional value, each of the plurality of electronic accounts comprising a plurality of data parameters including at least a balance value not accruing interest, a ledger sheet having an available-balance value initialized to the balance value, and an eligible decrement value;
a server communicatively connected to the computing memory, the server having stored thereon computer instructions that during execution cause the system to perform operations comprising:
querying the database to select an eligible decrement value from a first electronic account of the plurality of electronic accounts, the first account being associated with the first institution;
calculating a difference between a requested amount of deposits requested by a second institution from the first institution and a received amount of deposits received by the second institution from the first institution;
upon identifying that the difference between the requested amount of deposits and the received amount of deposits is positive:
querying the database to select a second electronic account from the plurality of electronic accounts, the second account being associated with the second institution;
updating the database to decrement at least the selected eligible decrement value from both a respective balance value of the first electronic account in which the selected eligible decrement value is held and the institutional value of the balance sheet; and
updating the database to increment the balance value of the second electronic account by the amount decremented from the balance value of the first electronic account and the institutional value of the balance sheet.

10. The system of claim 9, wherein the selected eligible decrement value is less than or equal to the calculated difference.

11. The system of claim 9, wherein
updating the database to decrement at least the selected eligible decrement value from both a respective balance value of the first electronic account in which the selected eligible decrement value is held and the institutional value of the balance sheet and
updating the database to increment the balance value of the second electronic account by the amount decremented from the balance value of the first electronic account and the institutional value of the balance sheet,
comprises updating the database until at least one of:
the total value decremented from the balance value of the first electronic account and incremented to the balance value of the second electronic account equals a maximum decrement amount;
the total amount decremented from the balance value of the first electronic account and incremented to the balance value of the second electronic account equals a predetermined amount; or
the total amount decremented from the balance value of the first electronic account and incremented to the balance value of the second electronic account equals the difference between the requested amount of deposits and the received amount of deposits.

12. The system of claim 9, the server having stored thereon computer instructions that during execution cause the system to perform operations further comprising:
upon identifying that the difference between the requested amount of deposits and the received amount of deposits is negative:
querying the database to select a second electronic account from the plurality of electronic accounts, the second account being associated with the second institution, and paying a greatest deposit fee to the first institution;
updating the database to decrement at least the selected eligible decrement value from the balance value of the second electronic account; and
updating the database to increment the balance value of the first electronic account and the institutional value of the balance sheet by the amount decremented from the balance value of the second electronic account.

13. The system of claim 9, wherein the selected eligible decrement value is equal to a difference between a present balance value of the first electronic account and a previous balance value of the first electronic account.

14. The system of claim 13, wherein the previous balance value is equal to the balance value of the first electronic account after a last updating the database to decrement at least the selected eligible decrement value from both a respective balance value of the first electronic account in which the selected eligible decrement value is held and the institutional value of the balance sheet has occurred.

15. The system of claim 13, wherein the previous balance value is less than the balance value of the first electronic account after a last updating the database to decrement at least the selected eligible decrement value from both a respective balance value of the first electronic account in which the selected eligible decrement value is held and the institutional value of the balance sheet has occurred.

16. The system of claim 13, wherein the previous balance value is greater than the balance value of the first electronic account after a last updating the database to decrement at least the selected eligible decrement value from both a respective balance value of the first electronic account in which the selected eligible decrement value is held and the institutional value of the balance sheet has occurred.

17. A system comprising:
a computing memory having a database stored therein, the database storing a balance sheet and a plurality of electronic accounts, the balance sheet being associated with a first institution and including at least an institutional value, each of the plurality of electronic accounts comprising a plurality of data parameters including at least a balance value not accruing interest;
a server communicatively connected to the computing memory, the server having stored thereon computer instructions that during execution cause the system to perform operations comprising:
querying the database to identify a first electronic account associated with a second institution, the balance value of the first electronic account comprising electronic deposits that have been decremented from respective balance values of at least one electronic account of the first institution and incremented to the balance value of the first electronic account;
calculating an electronic deposit fee based upon the balance value of the first electronic account;
querying the database to identify a second electronic account of the second institution;
querying the database to identify a third electronic account of the first institution;
updating the database to decrement at most the electronic deposit fee from the balance value of the second electronic account at a time based upon the electronic deposit fee paid by the second institution to the first institution; and
updating the database to increment both the balance value of the third electronic account and the institutional value of the balance sheet by the amount decremented from the balance value of the second electronic account.

18. The system of claim 17, the server having stored thereon computer instructions that during execution cause the system to perform operations further comprising:
querying the database to identify accounts associated with the second institution instead of a third institution based upon the second institution paying a greater electronic deposit fee to the first institution than the third institution.

19. The system of claim 17, wherein the electronic deposit fee is made at a predetermined interval.

20. The system of claim 17, the server having stored thereon computer instructions that during execution cause the system to perform operations further comprising:
receiving deposits at the first institution from an electronic omnibus account.

21. The system of claim 17, wherein the electronic deposit fee is paid via an automated clearing house payment or a Fedwire payment.

22. The system of claim 17, wherein the first electronic account and second electronic account are maintained by the second institution, the second institution being a participating institution and the first institution being a providing institution.

23. The system of claim 17, wherein
updating the database to decrement at most the electronic deposit fee from the balance value of the second electronic account at a time based upon the electronic deposit fee paid by the second institution to the first institution and
updating the database to increment both the balance value of the third electronic account and the institutional value of the balance sheet by the amount decremented from the balance value of the second electronic account,
comprises updating the database without incrementing the balance value or decrementing the balance value of a fourth electronic account.

24. The system of claim 17, wherein
updating the database to decrement at most the electronic deposit fee from the balance value of the second electronic account at a time based upon the electronic deposit fee paid by the second institution to the first institution, comprises:
updating the database to decrement at most the electronic deposit fee from the balance value of the second electronic account at a time based upon the electronic deposit fee paid by the second institution to the first institution;
querying the database to identify another electronic account;
updating the database to increment the balance value of the another electronic account by at most the amount decremented from the balance value of the second electronic account; and
updating the database to decrement the balance value of the another electronic account by the amount incremented to the balance value of the another electronic account.

25. The system of claim 17, wherein the deposit fee is the greatest deposit fee of a plurality of deposit fees.
